(19) United States
(12) Patent Application Publication
(10) Pub. No.: US 2008/0211229 A1
(43) Pub. Date: Sep. 4, 2008

(54) Angle key pipe coupling

(76) Inventor: Howard Hagiya, Hitachi-Ohta (JP)

Correspondence Address: PATRICK M. DWYER PC;#322, 14419 GREENWOOD AVENUE N, Seattle, WA, 98133, US

(21) Appl. No.: 11/714,266

(22) Filed: Mar. 1, 2007

(51) Int. Cl. F16L 21/00

(52) U.S. Cl. 285/373

(57) ABSTRACT

Two pipes ends with circumferential grooves are held rigid by a housing-type coupling with angled keys relative the central transverse plane of the coupling. Upon installation of the coupling, the angled keys engage both the inner groove wall nearest the pipe end and the outer groove wall farthest from the pipe end to hold the pipes rigidly without longitudinal, angular and rotational movement. The coupling advantageously installs in a position with both coupling halves' central transverse planes aligned with no, or very little, rotation, thereby preventing twisting of the internal gasket, which effects the gasket seal.

### TECHNICAL FIELD

The invention relates to pipe joints; more particularly, it relates to housing type pipe couplings for creating a sealed connection between coaxial groove ended pipes.

### BACKGROUND OF THE INVENTION

Housing type pipe couplings are widely used for axially joining two pipes together in such a way as to create a non-leaking union between the pipe ends. To prevent leakage, it is often desirable to prevent longitudinal, angular or rotational movement of the pipe ends within the coupling.

Generally, the coupling is formed of arcuate housing segments which are fastened around the pipe ends to form a generally ring-like, coupling housing. Typically, two segments are used, a pair of arcuate or generally semicircular housing halves, which are fastened together, often bolted together. Housing halves are substantially U or C-shaped in longitudinal cross section. The inwardly projecting peripheral edges of the housing halves (the top of the U-shaped cross section), also referred to herein as shoulders, are shaped with keys for interlocking within circumferential grooves in the pipe ends. The coupling is secured, often as bolts are tightened through bolt holes, until the key segments engage the circumferential grooves on the pipe ends fastening the pipes together. Where the two housing halves meet around the circumference of the pipes, a mating structure is often used to lock one housing half to the other and to add stability. A rubber gasket, also frequently U-shaped or C-shaped in longitudinal cross section, is typically arranged within the coupling in a gasket pocket formed by the U-shaped longitudinal cross section of the coupling housing, such that when the housing halves are tightened against the pipe ends the inner peripheral edges of the gasket are sealed against the pipe end portions.

Pipe ends are typically grooved using either a rolled or cut groove. A roll groove uses a rolling machine to displace the pipe walls forming a curved-edged groove containing a top corner and a bottom corner with the top corner to corner separation longer than the bottom corner to corner separation. The gasket sealing surface is the distance between the outer groove wall and the end of the pipe. A cut groove removes pipe material to form a groove with straight walls perpendicular to the longitudinal axis of the pipe and therefore has no rounded corners.

Whether rolled or cut, the groove manufacturing method must accommodate significant tolerances set by the AWWA C-606 for gasket sealing surface, groove width, groove diameter, and outer diameter. Any pipe coupling must also accommodate such dimensional variations. Many prior art pipe couplings have a serious disadvantage in that they cannot fully prevent longitudinal, angular or rotational displacement of the pipes since clearance is typically left between the key sections and side walls of the grooves formed on the pipes.

Several designs are in use which attempt to minimize longitudinal, angular or rotational movement of the pipe ends within the coupling. Angled self-adjusting couplings and tongue and groove style rigid couplings have slightly oval variable internal circumferential diameters that shrink when a coupling is tightened until it grips the pipe ends eliminating angular movement caused by variable outer diameters and groove depths. However, as key width is smaller than groove width to facilitate easy installation within tolerances, space between the key and corresponding groove allows for some longitudinal movement when pipes are exposed to pressure thrusts or thermal movement. Through these designs, longitudinal movement is effectively reduced, but never completely eliminated.

In attempts to eliminate longitudinal movement, couplings have been designed containing a crescent pocket and a crescent protrusion offset from a transverse central axis on abutting end surfaces of the arcuate housings, skewing the position of the housings about a rotational axis as the coupling is fastened and the crescent protrusion enters the crescent groove. Another design which skews the coupling around a rotational axis uses inclined end faces where the two parts of the coupling join. These designs result in the two coupling halves rotated oppositely around a rotational axis. Such rotation when the coupling is in a tightened position can result in a skewing of the gasket contained inside. This has the result of breaking the gasket seal and allowing fluid or gases to leak from the fastened pipes.

In other designs, fastening keys contain protrusions making contact with opposing side surfaces of opposing ends of each respective circumferential groove. As the key width must be smaller than the groove width to guarantee installation within tolerances, space between the key and corresponding groove can only be eliminated by rotating the two coupling halves around a rotational axis, and risking, at the widest groove tolerance, the skewing of the gasket as described above.

A housing type coupling is needed that effectively eliminates longitudinal, angular and rotational movement of the pipe ends within the coupling housing through improvement of the rigidity of the grooved coupling when tightened against the pipe ends. In addition, this coupling desirably has minimal rotation about any rotational axis to prevent interference with the gasket contained within the coupling.

### DISCLOSURE OF THE INVENTION

The disclosed pipe coupling eliminates longitudinal, angular and rotational movement of pipe ends within the coupling housing through improvement of the rigidity of the grooved coupling when tightened against the pipe ends, while, at the same time, minimizing rotation of the coupling halves relative each other. The disclosed pipe coupling performs satisfactorily while accommodating the dimensional variations of grooves rolled or cut into pipes according to the tolerances set by the AWWA C-606 for gasket sealing surface, groove width, groove diameter, and outer diameter. Because the keys of the disclosed coupling are angled, they allow the coupling to hold the pipe ends rigidly while staying in a position of relative non-rotation which prevents any interference with the seal of the gasket around the pipe ends. The angled keys allow the coupling to assume and retain a position having the central transverse planes of the two halves aligned with no, or very little, rotation.

For the purposes of discussion, it will be advantageous to define a line running through the circular center of the two pipes referred to herein as a coaxial line, and also to define a line running longitudinally through the assembled coupling referred to herein as the arc longitudinal axis. The arc longitudinal axis includes the midpoints of a chord connecting the two endpoints of each coupling arc. Also defined is a plane, referred to as a join plane. The join plane extends from the arc longitudinal axis and passes through points on the surfaces where, in a preferred embodiment, the two coupling halves meet to form a generally ring-like housing around the pipes. It is also advantageous to define a central transverse plane of the coupling as a plane which is perpendicular the arc longitudinal axis and transversely bisects each coupling half through the center. A line referred to herein as a transverse axis lies at the intersections of the join plane and the central transverse plane. Also defined is a coupling rotational axis. The rotational axis is perpendicular to the join plane, intersecting the arc longitudinal axis and contained within the central transverse plane.

The coupling is formed of a pair of arcuate housing halves, which are fastened around two grooved pipe ends. It is advantageous, for the purposes of discussion, to define each circumferential groove rolled or cut in the pipe ends as having an inner wall closest to the pipe end and an outer wall furthest from the pipe end when the pipes are held in an abutted position. When the two housing halves are joined circumferentially around the pipe ends, they form a generally ring-like coupling housing.

Optionally, the housing halves are generally U-shaped in cross section, the cross section being taken in any plane extending from the arc longitudinal axis, with the open end of the U-shaped cross section pointing radially inward toward the pipes when the coupling is fastened about the pipes. The two inner peripheral edges of the housing halves (the top of the U-shaped cross section), referred to herein as shoulders, are advantageously shaped with keys for fitting within the circumferential grooves in the pipe ends to aid in fastening the pipes together. A gasket, typically made of flexible material and also generally U-shaped or C-shaped in cross section, is arranged within the coupling. When the coupling is assembled around the pipes, the top of the U-shaped cross section of the gasket or the legs forming the open ends of the C-shaped cross section of the gasket, are sealed against the pipe end portions within the coupling.

Each of the keys projects in height profile radially toward the arc longitudinal axis of the coupling halves and are optimally cast to follow in height the same arc as the inner peripheral edges of the coupling halves and their shoulders. Each key has an arcuate surface facing radially inward, referred to herein as a face, and two side walls. The side wall closest the central transverse plane of the coupling is defined as the inner wall of the key. The wall farthest from the central transverse plane of the coupling is defined as the outer wall of the key. Each key is angled relative the central transverse plane of the coupling across the shoulder. A key is angled when a plane bisecting the key face, as it runs circumferentially along the arcuate opening, divides the key face into equal areas, and this plane is not parallel the central transverse plane of the coupling, but intersects the central transverse plane of the coupling, forming an angle between the two planes. Advantageously, each key is angled such that, when the coupling is fastened about the pipe ends, an inner wall of a key contacts the inner wall of the pipe groove and an outer wall of a key contacts the outer wall of the pipe groove.

Optimally, the coupling housing shoulders, U-shaped housing cross-section and gasket space are symmetrical around the central transverse plane of the coupling. In this embodiment, a central transverse plane bisects the coupling housing, housing shoulders, fastening means and mating apparatus into two mirror image halves of the coupling when considered without the keys. In one embodiment, only the projecting keys are angled relative the central transverse plane of the coupling.

It is a particularly advantageous aspect of the disclosed coupling that, because the keys are angled relative the central transverse plane of the coupling, when the coupling halves are fastened in circumferential position around the pipe ends, the two coupling halves are returned to a generally non-rotated position around the axis of rotation. This is a significant improvement over prior art, which depends upon a rotation between the couplings to accomplish rigidity and as explained above may cause the gasket to skew and leak.

Advantageously, the face of each arcuate key, when observed in plan view, is generally in the shape of a parallelogram with two long sides and two short. In this embodiment, the two long sides define the length of the key, which is also the length of the inner and outer walls of the key. A perpendicular connecting the two long sides of the parallelogram defines the width of the key. Optimally, the width of each key fits easily within the smallest tolerance set for the groove width of a pipe. Again, each key is angled relative the central transverse plane of the coupling across the shoulder.

Optionally, each shoulder has one key which runs the entire length of the arcuate opening. Such a disposition places two keys on each coupling half with a key on each side of the central transverse plane of the coupling. The keys upon the same coupling half, in this embodiment, are of equal length and the angle formed relative the central transverse plane by each key's side walls are generally congruent (i.e. the angles are of the same measurement), such that the keys on a coupling half are generally parallel. In this embodiment, when the two coupling halves are held side by side with the interior of the coupling half arcs facing up towards the viewer, the angles of all the four keys (two on each half) are congruent relative the central transverse planes of each half and all four keys appear parallel. Advantageously, each coupling half may be cast from the same mold. However, it should be noted that when the coupling halves are joined circumferentially around the pipes, the central transverse planes of the coupling halves generally align, and the angles formed between the keys and the now generally aligned central transverse planes are in opposition. This relative positioning of keys is hereby defined as “oppositely oriented”. While the angles have the same measure relative the central transverse plane, they are oppositely oriented relative the central transverse plane in that the key angles of one coupling half angle in one direction relative the central transverse plane and the key angles of the other coupling half angle in the opposite direction relative the central transverse plane of that coupling half. In this particular embodiment, where a key from each coupling half engages the same circumferential groove, an imaginary X-ray perception that could discern the key faces from a point on the central transverse plane outside the coupling would perceive the key faces as an “X” pattern within each of the two circumferential pipe grooves.

In a basic embodiment of the disclosed pipe coupling, at least one arcuate key projects generally radially inward with the key being angled relative a transverse plane of the coupling. Such a key will have a key face when viewed in plan view from the interior of the arcuate opening and, therefore, can be defined as angled by the definition above.

Expanding upon this basic embodiment, a coupling has at least two angled keys, such that each coupling half has at least one key projecting generally radially inward.

In a preferred embodiment, an angled key has a radially inwardly facing arcuate face with a plan view of the key face being of generally parallelogramatic shape. This creates two key side walls as well, an inner wall being closest to the central transverse plane and an outer wall being farthest from the central transverse plane. The length of the side walls of such a parallelogramatic shape can be defined as the length of the key. In one embodiment, which has such parallelogramatic shaped key faces, multiple keys are present and the key's lengths are generally equivalent to one another. In a further refinement of this embodiment, each coupling half has exactly two angled keys, one on each side of the central transverse plane, the two angled keys extend generally radially inward the full length of the arcuate opening of the coupling half and the two angled keys upon a single coupling half are parallel to each other.

It is advantageous that the coupling be formed by two joined arcuate coupling halves and that the two halves, when joined, form an opening for the pipes which is slightly oval, the long axis of the oval lying in the join plane of the coupling.

The minimal requirement for the functioning of the coupling disclosed requires each coupling half to have at least one angled key. In this minimal embodiment, the two keys of the system are disposed such that each pipe groove (one on each pipe) has contact with a key, the inner wall of the key contacting the inner wall of the pipe groove and the outer wall contacting the outer wall of the pipe groove. This disposition results in a configuration of at least two angled keys herein defined as oppositely oriented, relative the central transverse plane of the coupling. They are oppositely oriented relative the central transverse plane in that the key angles of one coupling half angle in one direction relative the central transverse plane and the key angles of the other coupling half angle in the opposite direction relative the central transverse plane of that coupling half. The opposite orientation of the keys pulls the two pipe ends together, when the coupling halves are fastened together in position around the pipes.

Optionally, a shoulder may have a plurality of angled keys. In one embodiment contemplated each key has a radially inward facing face and two side walls with the key face in the general shape of a parallelogram, when observed in a plan view. The side walls of the angled keys are optionally of generally equivalent length to one another. Optionally, keys are parallel upon a shoulder and upon a single coupling half. The keys upon the other coupling half are disposed in opposite orientation when the coupling is joined to form a generally ring-like housing. Another option is to dispose the keys in a linear arrangement, such that a plane may bisect all the keys on the same shoulder. In such an embodiment, one key has an inner wall with point of contact with the inner wall of a pipe groove, but no points of contact with the outer wall of the pipe groove. Another key in a linear arrangement upon the same shoulder has a point of contact with the outer wall of the same pipe groove, but no points of contact with the inner wall of the pipe groove.

Optionally, each coupling half has two angled keys, disposed one on each side of the central transverse plane, such that one key engages each of the circumferential grooves of two pipes when the pipes are placed in coaxial engagement. In another embodiment contemplated, the keys do not run the entire length of the shoulder and meet at the join plane as described above. The single key on each shoulder is still disposed such that the inner wall of the key contacts the inner wall of the pipe groove and the outer wall contacts the outer wall of the pipe groove, when the coupling is tightening in circumferential position around two pipes.

To restate, an embodiment of the housing type coupling disclosed herein is a pipe coupling apparatus for joining together a pair of pipe ends in coaxial engagement, each pipe end shaped with a circumferential groove, the circumferential groove having two walls, an outside wall and an inside wall relative a central transverse plane of the coupling. The pipe coupling apparatus is formed by two arcuate shaped coupling halves and with a plurality of keys projecting substantially radially inward from a coupling half. Each of the plurality of keys is angled relative a central transverse plane of the coupling, such that when the coupling is fastened about the pipe ends, each key has at least one point of contact moveable to engage at least one of the two walls of the circumferential groove. In addition, the plurality of keys are disposed such that: 1) each coupling half has at least one key projecting radially inward, 2) each pipe's circumferential groove has at least one point of contact of at least one key moveable to engage the outside wall of the circumferential groove and a second at least one point of contact of at least one key moveable to engage the inside wall of the circumferential groove, and 3) at least two of the plurality of angled keys are oppositely oriented relative the central transverse plane of the coupling when the two coupling halves are circumferentially positioned about the pipe ends.

Given the preceding paragraph's embodiment, an optional addition is that each of the plurality of keys have a radially inwardly facing arcuate face and two side walls with a plan view of the face having a generally parallelogramatic shape. Each key may be of generally equivalent length, and the keys projecting from a single coupling half are optionally parallel to each other, relative the central transverse plane of the coupling.

As described above, when the two housing halves are joined circumferentially around the pipe ends, they form the generally ring-like coupling housing. Optionally, the coupling halves will meet in metal to metal connections at the join plane, providing a metal shielding about every outside surface of the gasket. This has the advantage of protecting the gasket from deterioration through outside forces. Advantageously, the two halves, when joined, form an opening for the pipes which is slightly oval, the long axis of the oval lying in the join plane of the coupling.

Coupling are fastened together with fastening means such as bolts, clips, pins, rivets, snapping apparatus or any fastening means now known or later developed. Optionally, the coupling halves are bolted together, using flange like extensions referred to herein as bolt pads. In this arrangement, the bolt holes through which the bolts pass are advantageously oblate to allow for a slight rotation of the coupling halves opposite one another around a rotational axis defined above. A slight rotation may remain, after the couplings are tightening into a circumferential position, depending upon the particular clearances of the pipe grooves. As discussed above, it is a particularly advantageous aspect of the disclosed coupling that, because the keys are angled relative the central transverse plane of the coupling, when the coupling halves are fastened in circumferential position around the pipe ends, the apparatus is returned to a generally non-rotated position around the axis of rotation.

To assure the correct orientation of the coupling halves to one another, it is advantageous to employ additional mating structures, such as a tongue and groove, where the coupling halves meet at the join plane. While a tongue and groove structure is advantageous, other methods of assuring correct alignment well known in the art or later developed, such as a V or semi-circular shaped mated pairing, may be used. Optimally, such structures are employed proximate the region of the bolt holes to align and mate the coupling halves. As explained above, it is advantageous to allow for a slight rotation of the coupling halves opposite one another around a rotational axis in the design of the mating structure, as a slight rotation may remain, after the couplings are tightening into a circumferential position, depending upon the particular clearances of the pipe grooves.

Two pipes ends with circumferential grooves are desirably held rigid by a housing-type coupling with angled keys relative the central transverse plane of the coupling. Upon installation of the coupling, the angled keys engage both the inner groove wall nearest the pipe end and the outer groove wall farthest from the pipe end to hold the pipes rigidly without longitudinal, angular and rotational movement. The coupling advantageously installs in a position with both coupling halves' central transverse planes aligned with no, or very little, rotation, thereby preventing twisting of the internal gasket, which effects the gasket seal.

While a pair of coupling halves similarly cast with keys extending the full length of the coupling shoulder, the keys being parallel and each key engaging an inner and outer wall of the pipe groove, is an advantageous embodiment of the disclosed coupling, it should be understood that any embodiment with an angled key as defined above is disclosed. Coupling halves with single or multiple angled keys upon a shoulder in any arrangement are contemplated. In the disclosed coupling's simplest form, only two angled keys are required, one on each coupling half, disposed such that each pipe's circumferential groove has one point of contact of a key moveable to engage the outside wall of the circumferential groove and a second point of contact of the key moveable to engage the inside wall of the circumferential groove and that the angled keys are oppositely oriented relative the central transverse plane of the coupling when the two coupling halves are circumferentially positioned about the pipe ends.

### BRIEF DESCRIPTION OF THE DRAWINGS

FIG. 1 is an interior top view of a pipe half.

FIG. 2 is a cross-sectional view of a pipe coupling half.

FIG. 3 is an interior top view of a pipe coupling half.

FIG. 4 is a schematic front perspective view of a pipe coupling.

FIG. 5 is a front view of a pipe coupling half.

FIG. 6 is a front perspective view of a pipe coupling circumferentially fastened around a pipe end.

FIGS. 7a and 7b are interior top views of alternate embodiments of a pipe coupling half.

### BEST MODE OF CARRYING OUT THE INVENTION

Turning now to the drawings, the disclosed coupling will be described in a preferred embodiment by reference to the numerals of the drawing figures wherein like numbers indicate like parts.

For the purposes of discussion of the drawings, it will be advantageous to restate definition of a line running through the circular center of the two pipes referred to herein as a coaxial line, and also to define a line running longitudinally through the assembled coupling referred to herein as the arc longitudinal axis. The arc longitudinal axis includes the midpoints of a chord connecting the two endpoints of each coupling arc. Also defined is a plane, referred to as a join plane. The join plane extends from the arc longitudinal axis and passes through points on the surfaces where, in a preferred embodiment, the two coupling halves meet to form a generally ring-like housing around the pipes. It is also advantageous to define a central transverse plane of the coupling as a plane which is perpendicular the arc longitudinal axis and transversely bisects each coupling half through the center. A line referred to herein as a transverse axis lies at the intersections of the join plane and the central transverse plane. Also defined is a coupling rotational axis. The rotational axis is perpendicular to the join plane, intersecting the arc longitudinal axis and contained within the central transverse plane.

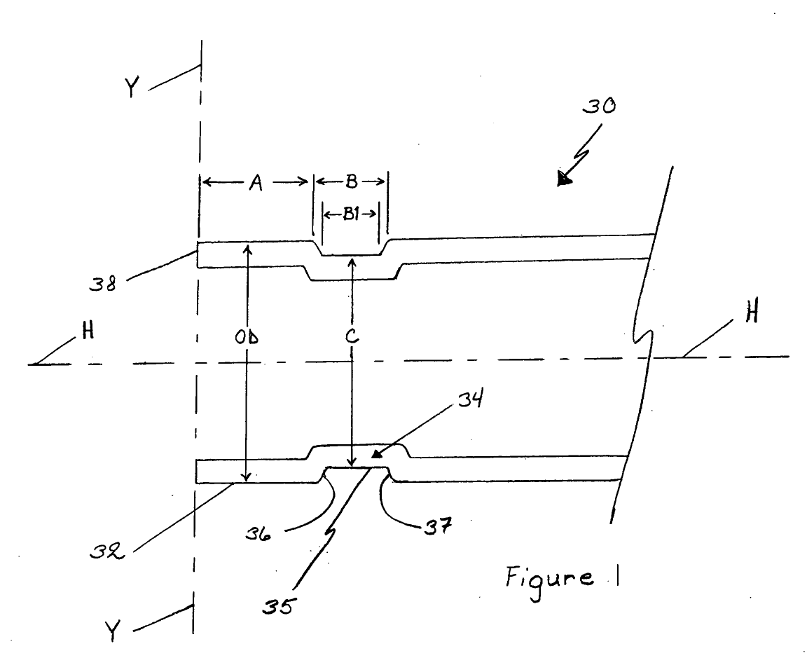

FIG. 1 is an interior top view of a pipe cut along a longitudinal plane containing a coaxial line H-H as defined above. A groove 34 has been rolled into pipe end 30, groove 34 having a floor 35, an inner wall 36 and an outer wall 37, inner wall 36 being closest to the end surface 38 of the pipe, and outer wall 37 being farthest from end surface 38 of the pipe. Gasket sealing surface 32 abuts pipe end surface 38 and the outer edge of wall 36. For the purpose of clarity, the illustration does not reflect standard pipe dimensions.

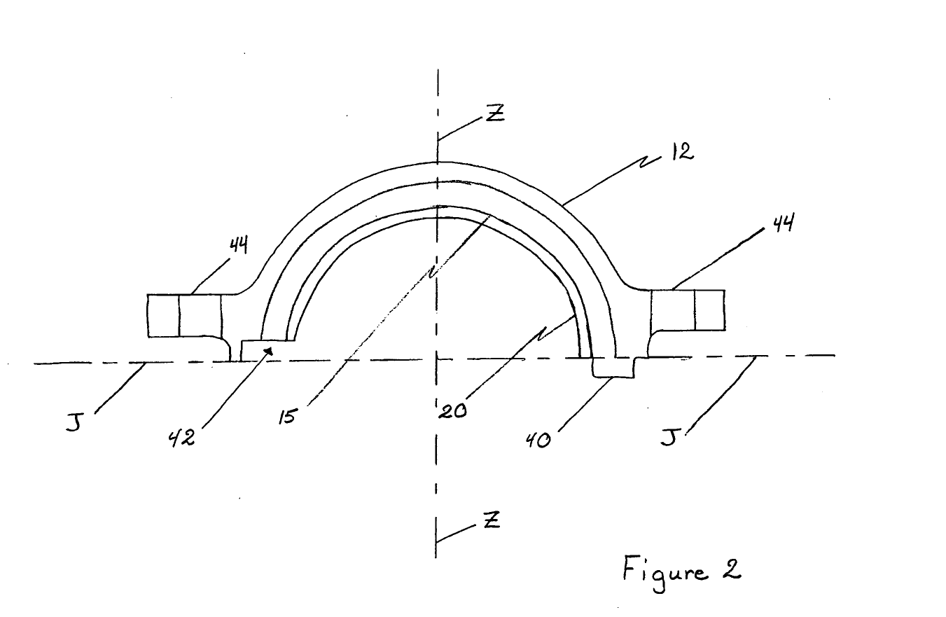

FIG. 2 is a cross-sectional view of one embodiment of a disclosed pipe coupling half 12 bisected along the central transverse plane as defined above. Coupling half 12 is an arcuate shaped coupling half sized to fit around two pipe ends 30. The line J-J lies in the join plane as defined above, where it is advantageous for the two coupling halves to meet metal to metal forming a solid ring about pipe ends 30. Projecting radially inward from shoulder 15 is key 20. Key 20 engages with roll grooves 34 to connect the pipe ends 30 in an abutting position. Keys 20 prevent pipe ends 30 from slipping out of coupling 10 and hold the two pipe ends 30 rigid. Use of disclosed rigid coupling 10 eliminates or minimizes angular movement (pipe deflection), rotational movement (pipe rotation) and or linear movement (longitudinal movement of pipe) that are seen in a joint with a flexible coupling.

Also illustrated in FIG. 2 is a tongue 40 and a corresponding groove 42. In this embodiment, tongue and groove mating between coupling half 12 and similarly cast coupling half 13 assure a correct mating of coupling halves around the pipes. It is advantageous for the mating structure to assure a correct assembly of the similarly cast coupling halves as this also assures the opposite orientation of angled keys 20 in pipe groove 34. Tongue 40 and groove 42 are dimensioned with a slight clearance (i.e. the tongue dimensioned smaller than the groove) to allow a slight rotation around rotational axis Z-Z.

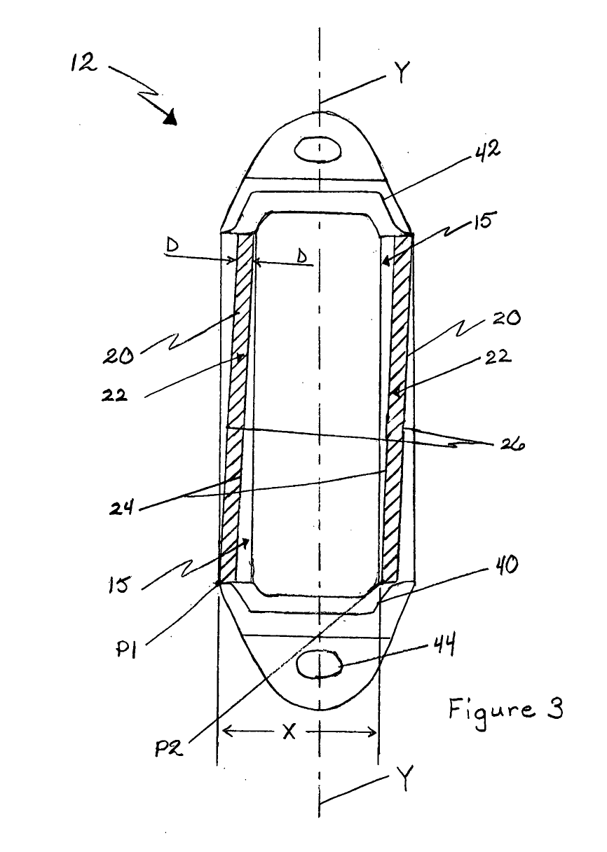

FIG. 3 is an interior top view of one embodiment of a disclosed pipe coupling half 12. A central transverse plane as defined above, containing transverse line Y-Y, bisects coupling housing 10, housing shoulders 15, fastening means and mating apparatus (i.e. the coupling without keys 20) into two mirror image halves of coupling half 12.

Projecting radially inward from coupling shoulders 15 are two angled keys 20. The shaded areas illustrate faces 22 of each key 20. Each key face 22 is generally parallelogramatic in shape, when observed in plan view, with one long side of the parallelogram meeting the inner key wall 24 and the other long side of the parallelogram meeting outer key wall 26. Inner walls 24 of key 20 are closest to the central transverse plane containing transverse line Y-Y and outer walls 26 are farthest from the central transverse plane. In this embodiment, each coupling shoulder 15 has angled across it one key 20. The two keys 20 are generally parallel one another. That is to say, the long sides of the parallelograms are generally parallel.

A perpendicular connecting the two long sides of the facial parallelogram defines the width of each key 20, the width being illustrated in FIG. 3 between arrows D-D. In this embodiment, each key 20 has a constant width the length of the arcuate opening. It is advantageous for the width of key 20 to be smaller than the width of rolled groove 34 taken at the outside dimension of a pipe circumference (i.e. the width across the groove measured at the top of groove walls 36 and 37). Advantageously, key width is designed to be about 70% of the width across groove 34 measured at the top of groove walls 36 and 37. This allows keys 20 to fit inside groove 34 even if groove 34 is manufactured smaller than the accepted standards.

Optimally, two keys 20 are disposed, one each upon the two shoulders 15, such that the keys 20 are parallel to one another and angled. A key is angled when a plane bisecting the key face, as it runs circumferentially along the arcuate opening, divides key face 22 into equal areas, and this plane is not parallel the central transverse plane of the coupling, but intersects the central transverse plane of the coupling, forming an angle between the two planes. In this embodiment, such a plane, as well as the long sides of the facial parallelograms, which also define the upper edge of inner walls 24 and outer walls 26, form angles with the central transverse plane according to the following formula,

Tan θ=(B1−D)/C

where:
θ is the angle between a key wall 24 or 26 and the central transverse plane f the coupling;
B1 is the width of roll groove floor 35;
C is a diameter taken across the center of the pipe from roll groove floor 35 to the opposing roll groove floor 35; and
D is a width of key 20 as defined above.
   This formula is based upon a preferred embodiment in which a plane defined by the outer faces of coupling 10 is parallel to the transverse axis, illustrated as line Y-Y. Otherwise, the angle is with respect to the central transverse plane. It also follows that the angle is with respect to the arc longitudinal axis, but with a different formulation as will be appreciated by those skilled in the art.

Below is a table displaying standard pipe dimensions for the relevant parameters of the above formula and the resultant angle formed between the central transverse plane and key inner and outer walls 24 and 26 for couplings of different sizes. B1-D is constant throughout the table. These numbers are based on RIDGID standard pipe groove dimensions, as RIDGID sells the most widely used pipe grooving machines in the U.S. today. The table below has groove widths that are standard RIDGID lengths for 2″ to 6″ pipe sizes. It is advantageous that, since 8″ pipes have different dimensions, 8″ couplings have a different key size.

Angle-Key Coupling

| | | C | B | B1 | D | | |
|---|---|---|---|---|---|---|---|
| Size | OD | (Gr. Dia. | (Top Gr. Wd. | (Bottom Gr. Wd. | (Key Wd. | B1 − D | Angle θ |
| (in.) | (Outer Dia. mm) | mm) | mm) | mm) | mm) | (mm) | (Degrees) |
| | | | Roll Groove | | | | Degrees |
| 2 | 60.3 | 57.2 | 8.7 | 7.5 | 5.5 | 2.0 | 2.00 |
| 2.5 | 73.0 | 69.1 | 8.7 | 7.5 | 5.5 | 2.0 | 1.66 |
| (2.5) | 76.1 | 72.2 | 8.7 | 7.5 | 5.5 | 2.0 | 1.59 |
| 3 | 88.9 | 84.9 | 8.7 | 7.5 | 5.5 | 2.0 | 1.35 |
| 4 | 114.3 | 110.1 | 8.7 | 7.5 | 5.5 | 2.0 | 1.04 |
| (5) | 139.7 | 135.5 | 8.7 | 7.5 | 5.5 | 2.0 | 0.85 |
| 5 | 141.3 | 137.0 | 8.7 | 7.5 | 5.5 | 2.0 | 0.84 |
| (6) | 165.1 | 160.8 | 8.7 | 7.5 | 5.5 | 2.0 | 0.71 |
| 6 | 168.3 | 164.0 | 8.7 | 7.5 | 5.5 | 2.0 | 0.70 |
| (8) | 216.3 | 211.6 | 11.9 | 10.7 | 8.7 | 2.0 | 0.54 |
| 8 | 219.1 | 214.4 | 11.9 | 10.7 | 8.7 | 2.0 | 0.53 |

Coupling sizes in parentheses represent BS (UK) and/or JIS (Japan) standards

It is also advantageous to dispose keys 20 in the above embodiment such that the distance between keys from the inside wall 24 of one side key to outside wall 26 of the other key is designed to have a value of,

X=2A+B

where:
X is the distance between keys from inner wall 24 of one shoulder's key to outer wall 26 of the other shoulder's key taken across a perpendicular connecting the two keys 20;
   A is the length of gasket sealing surface 32, measured from the pipe end surface 38 to the top of inner groove wall 36; and
   B is roll-groove width measured across the groove at the top of groove walls 36 and 37.

In this embodiment, when grooves 35 have the standard RIDGID bottom corner to corner widths (distance B1 in FIG. 1) and top corner to corner widths (distance B in FIG. 1), a point of contact will engage opposing walls at each end of keys 20. Optimally, the distance X in FIG. 3 between the groove outer wall contact point of a first pipe (P1 in FIG. 3) and (P2 in FIG. 3) the groove inner wall contact point on the other second pipe (or the groove inner wall contact point of a first pipe and the groove outer wall contact on the other second pipe) is given by the above formula (X=2A+B). The table below displays values for X given some parameters of standard pipes.

| | A | B | X |
|---|---|---|---|
| | (gasket | (Groove | (Distance Between P1 and |
| Coupling Size | sealing surface) | width) | P2) |
| 2″-6″ | 15.9 | 8.7 | 40.5 |
| 8″-12″ | 19.1 | 11.9 | 50.1 |

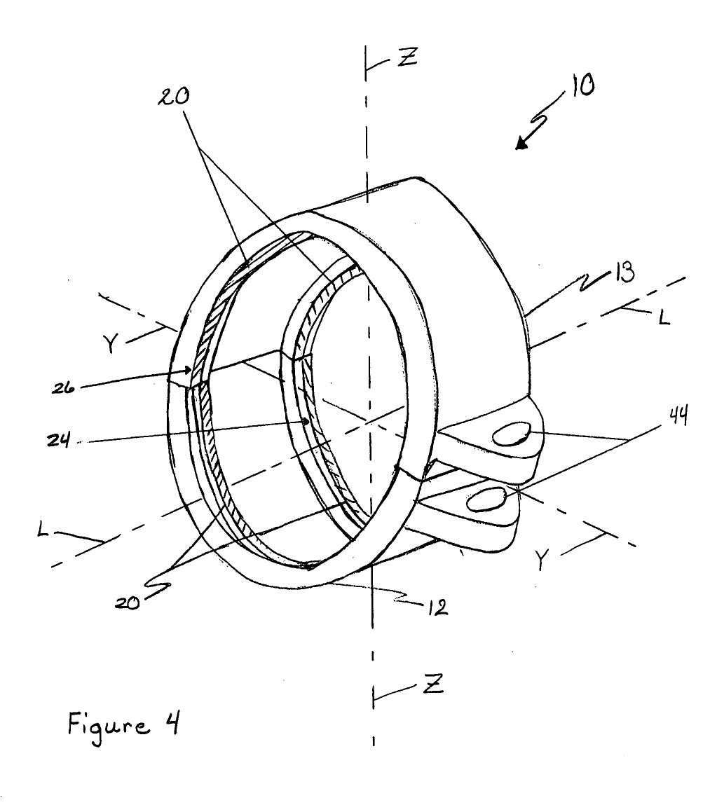

FIG. 4 is a schematic front perspective view of one embodiment of disclosed pipe coupling 10. In this embodiment, coupling half 12 is fastened to similarly cast coupling half 13 to form a rigid ring enclosing pipe ends 30, by bolting the halves together, the bolts passing through bolt holes 44. Bolt holes 44 are advantageously ovoid in shape, as can be seen in FIG. 3, allowing for a slight rotation around rotational axis Z-Z as defined above.

Coupling half 12 is combined with a generally identically cast coupling half 13. Tongue 40 of coupling half 12 is inserted into adjacent groove 42 of coupling half 13 forming generally ring-like coupling 10. This means that if both coupling halves are held side by side so that all keys 20 are parallel, one coupling half is rotated 180 degrees about transverse axis Y-Y and 180 degrees about rotational axis Z-Z, essentially flipped and rotated 180 degrees horizontally, for coupling halves 12 and 13 to merge. The end result is an opposite orientation of keys 20 between coupling halves 12 and 13. Parallel key 20 pairings on separate coupling halves angle equally in opposite directions relative to the central transverse plane of the coupling half, creating a transverse “X” pattern between corresponding key 20 pairings of respective housings acting on each respective pipe end groove 34. In this relationship, at least two points of contact, one from a key 20 on each of coupling halves 12 and 13, will engage groove walls 36 and 37 on opposing sides, where coupling halves 12 and 13 meet in the general vicinity of the join plane.

This relationship can be seen in FIG. 4, where one key 20 of coupling 13 in the vicinity of the join plane meets key 20 of coupling 12 in an overlapping abutment. In this embodiment, an end of a key wall 24 or 26 of separate coupling halves will be in contact with opposing walls proximate the join plane. When coupling 10 is in a circumferential position around grooved pipe end 30, outer key wall 26 of coupling half 13 will engage outer groove wall 37 of pipe end 30 proximate the join plane, while inner key wall 24 of coupling 12 will engage inner groove wall 36 of pipe end 30 near the same position on the join plane. In addition, in this embodiment, inner wall 24 of a key will contact inner groove wall 36, while at the other end of the key, outer key wall 26 contacts outer wall 37 of the same groove. Thus, contact between keys 20 and pipe groove walls is achieved at both inner groove wall 36 and outer groove wall 37 in each pipe end 30, eliminating longitudinal movement of pipe ends 30 and creating a truly rigid grooved coupling.

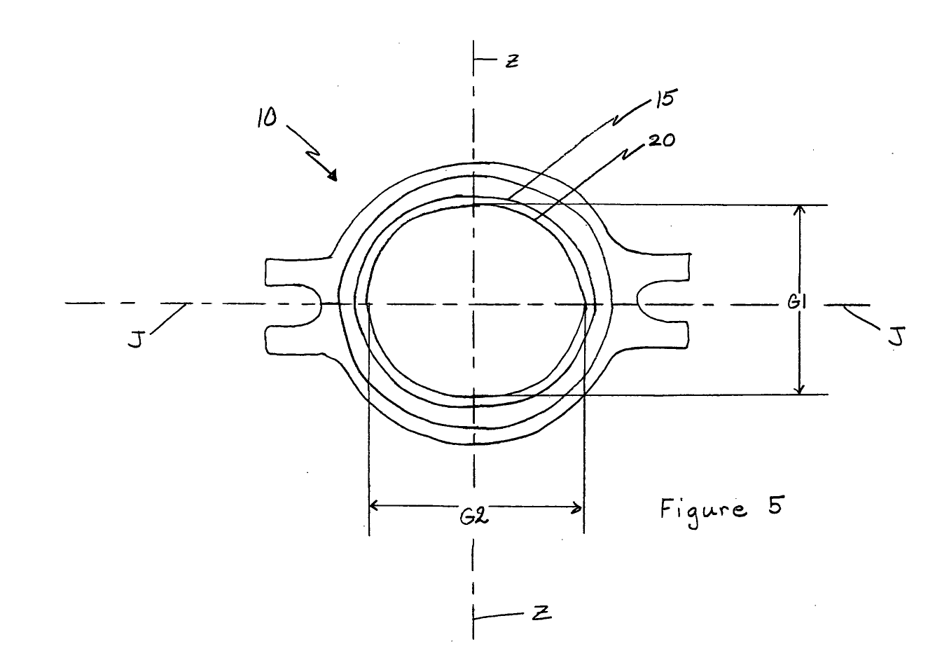

FIG. 5 is a front view of a pipe coupling half. It is advantageous that the arcuate shape of coupling 10 be designed such that the interior opening through which the pipes pass is slightly oval. Optimally, when coupling halves 12 and 13 are assembled as shown in FIG. 5, the long axis of the ovoid opening is congruent with line J-J and the short axis is congruent line Z-Z. In FIG. 5, distance G1 is less than distance G2. The difference in the distances has been exaggerated in the drawing for the sake of clarity. With this design, coupling housing 10 holds pipe ends 30 tightly and prevent them from rotating. It is advantageous that the short axis dimension be such that two coupling halves 12 and 13 make a metal-to-metal contact at the join plane (line J-J in FIG. 5) when installed on pipe ends 30.

An advantageous formula to use for the dimensioning of the ovoid interior opening is,

G1<G2

G1=Cmin−k

G2=Cmax+k

where:
G1 is the ovoid opening dimension along line Z-Z in FIG. 4;
   G2 is the ovoid opening dimension along line J-J in FIG. 4;
   Cₘᵢₙ is a diameter taken across the center of pipe from roll groove floor 35 to opposing roll groove floor 35 (see FIG. 1), for a groove 34 rolled to the smallest dimension allowed for C by standards well known in the art; and
   Cmax is a diameter taken across the center of the pipe from roll groove floor 35 to opposing roll groove floor 35 (see FIG. 1), for a groove 34 rolled to the largest dimension allowed for C by standards well known in the art;
   k is a tolerance that is generally accepted in the art for iron castings.
      This dimensioning is advantageous in that coupling 10 of this particular embodiment fits around any pipe groove 34 rolled to acceptable standards. A metal to metal contact at the join plane (line J-J in FIG. 5) is desirable. In the case that a coupling does not form a complete ring when circumferentially positioned around pipe ends 30, high pressure in pipes could push against the rubber gasket causing it to protrude and break the leak free seal of the gasket against pipe end surface 32.

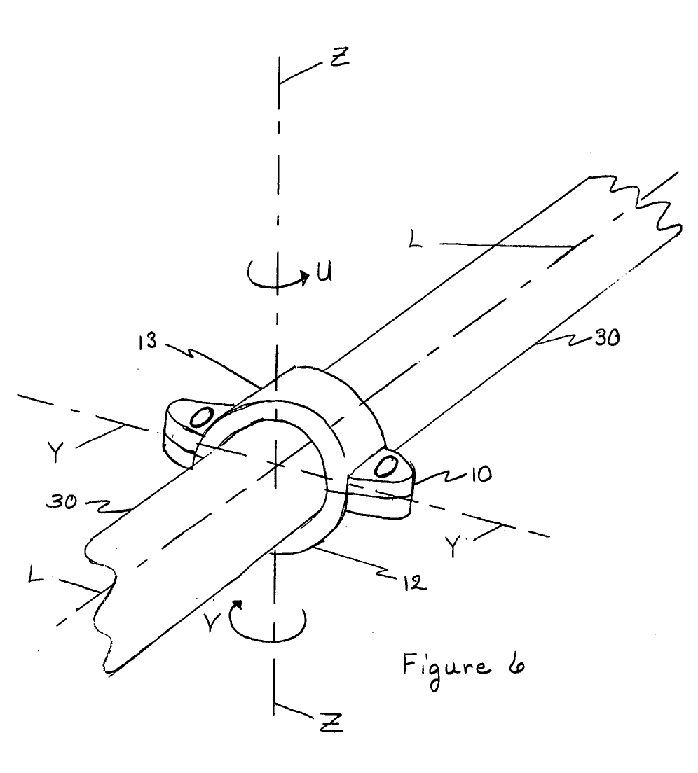

FIG. 6 is a front perspective view of one embodiment of a disclosed pipe coupling circumferentially fastened around a pipe end. Line L-L is an arc longitudinal axis as defined above. Line Y-Y is the transverse axis and lies in the join plane as defined above. Line Z-Z is the rotational axis as defined above. Coupling halves 12 and 13 are bolted in a tightened position circumferentially around pipe ends 30. In general, when installed the coaxial line of the pipes is generally aligned with the arc longitudinal axes of coupling halves 12 and 13. Keys 20 are engaged with grooves 35 attaining rigidity of the assemblage.

A method of installation of this embodiment will now be discussed. When a coupling housing half 12 is mounted from behind butted and straight-aligned roll-grooved pipe ends 30, coupling half 12 is rotatable around axis Z-Z in the direction indicated by arrow U. Rotation is possible because keys 20 are angled relative the central transverse plane of the coupling and keys 20 are of a lesser width than the width of groove 35 measured at the top of groove walls 36 and 37. Likewise, when another coupling housing is mounted from the front, it would be rotatable around axis ZZ in the direction indicated by arrow V, because keys 20 are oppositely oriented when coupling halves 12 and 13 are placed in circumferential position.

In this embodiment, as the bolts and nuts are fastened, keys 20 engage grooves 35 such that at least one point of contact on key inner wall 24 will engage groove inner wall 36 for each key and at least one point of contact on key outer wall 26 will engage groove outer wall 37 for each key. Keys 20 engage grooves 35 in an angled position relative the central transverse plane of coupling halves 12 and 13 bringing rotating coupling half 12 in the direction of arrow V and coupling half 13 in the direction of arrow U. As keys 20 engage pipe grooves 35 extending across the width of roll-groove 35, coupling halves 12 and 13 come back to a position where the coupling half central transverse planes are generally aligned, to the extent allowable by the width of roll groove 34 at the points of contact, where each key 20 engages. As discussed above, an optimum distance between keys 20 is designed such that two pipe ends 30 come to butt tightly against each other, successfully eliminating linear movement of pipe. Since in this embodiment, the inner diameter of circumferentially placed coupling halves 12 and 13 is ovoid, keys 20 grasp pipe groove 34 from both sides to eliminate both angular movement (pipe deflection) and rotational movement (pipe rotation). In this embodiment, bolts and nuts are tightened until coupling halves 12 and 13 come to a metal-to-metal contact; the joint is complete.

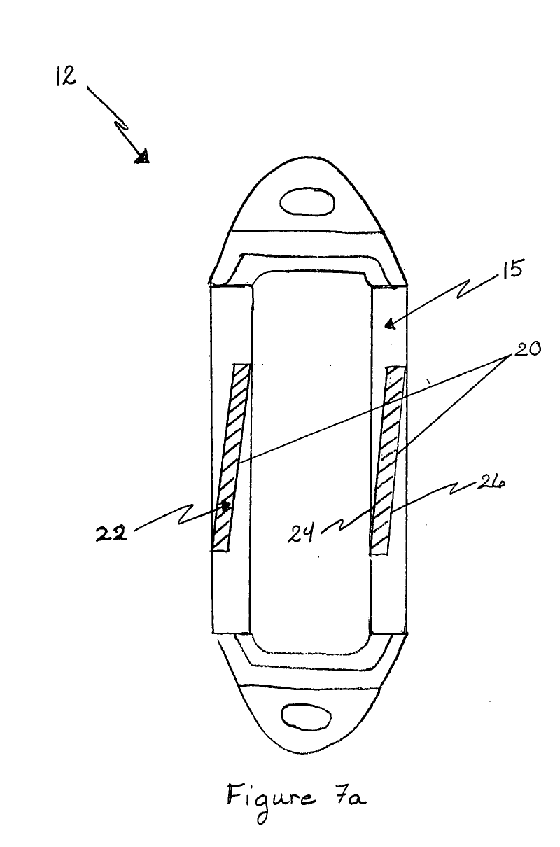

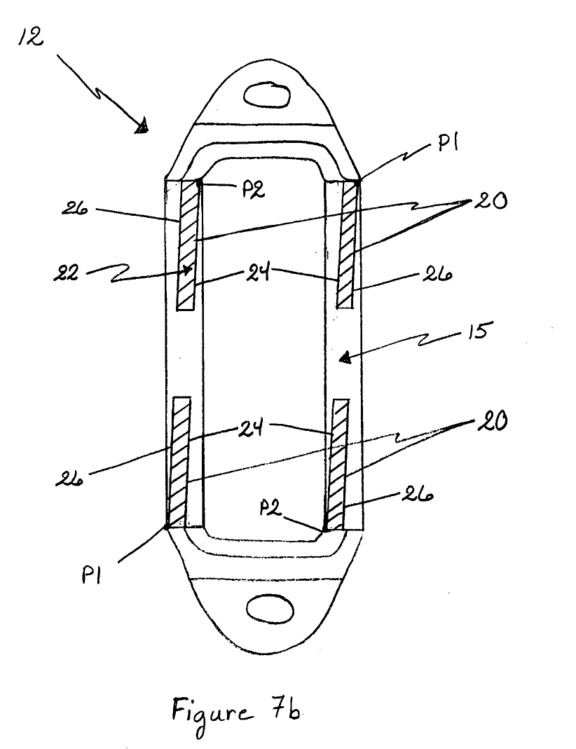

FIGS. 7a and 7b are interior top views of alternate embodiments of a pipe coupling half. In FIG. 7a, two angled keys 20 project radially inward from coupling shoulders 15. The shaded areas illustrate faces 22 of each arcuate key 20 when viewed in plan view. Similar to the coupling embodiment of FIG. 3, each key face 22 is generally parallelogramatic in shape, when observed in plan view, and the two keys 20 are angled and generally parallel one another. That is to say, the long sides of the parallelograms are generally parallel. Since a plane bisecting each key face 22, as it runs circumferentially along the arcuate opening, dividing key 22 into equal areas, is not parallel the central transverse plane of coupling half 12, but intersects the central transverse plane of coupling half 12 at an angle, keys 20 are angled. The embodiment of FIG. 7a is distinguished over the embodiment of FIG. 3 in that angled keys 20 do not run the full length of the arcuate opening and, therefore do not abut at the join plane. If coupling half 12 is combined with a similarly cast opposing coupling half, keys 20 have opposite orientation, resulting in parallel key 20 pairings on separate coupling halves angled equally in opposite directions relative to the central transverse plane of coupling half 12, creating the transverse “X” pattern described above. As in the coupling half 12 of FIG. 3, each key has at least two points of contact, one from an inner key wall 24, which engages pipe groove inner wall 36, and one from an outer key wall 26, which engages pipe groove outer wall 37. It will be appreciated by those skilled in the art that, to calculate an angle for keys 20 disposed as in FIG. 7a, a different formula than the one disclosed for the embodiment of FIG. 3 is used.

FIG. 7b illustrates an example of an embodiment of the disclosed coupling with multiple keys on separate shoulders 15 of a coupling half 12. Multiple angled keys 20 project generally radially inward from coupling shoulders 15. The shaded areas illustrate faces 22 of each arcuate key when viewed in plan view. In this embodiment, each key, while angled according to the above definition, does not engage a pipe groove 34 at two contact points. Two of the four keys 20 illustrated in FIG. 7b engage an outer pipe groove wall 37 at a contact point (P1) on an outer key wall 26, while the other two of the four keys 20 engage a pipe groove wall 36 at a contact point (P2) on an inner key wall 24. In this embodiment, each key has one wall 24 or 26 which does not engage a pipe groove wall, when coupling 10 is fastened in circumferential position about pipe ends 30.

FIGS. 7a and 7b are exemplary of many possible angled key combinations and not intended to limit other possible variations. Any embodiments of housing type pipe couplings using an angled key, as defined above, are disclosed.

With regard to systems and components above referred to, but not otherwise specified or described in detail herein, the workings and specifications of such systems and components and the manner in which they may be made or assembled or used, both cooperatively with each other and with the other elements of the disclosed coupling described herein to effect the purposes herein disclosed, are all believed to be well within the knowledge of those skilled in the art. No concerted attempt to repeat here what is generally known to the artisan has therefore been made.

### INDUSTRIAL APPLICABILITY

The disclosed pipe coupling with its angled keys eliminates longitudinal, angular and rotational movement of pipe ends within the coupling housing through improvement of the rigidity of the grooved coupling when tightened against the pipe ends. It performs satisfactorily while accommodating the dimensional variations of grooves rolled or cut into pipes according to the tolerances set by the AWWA C-606 for gasket sealing surface, groove width, groove diameter, and outer diameter. Because the keys of the disclosed coupling are angled, the coupling assumes and retains a position having the central transverse planes of the two halves aligned with no, or very little, rotation. This prevents the gasket twisting and subsequent leakage that is observed in the field in couplings produced according to prior art.

In compliance with the statute, the disclosed coupling has been described in language more or less specific as to structural features. It is to be understood, however, that the disclosed coupling is not limited to the specific features shown, since the means and construction shown comprise preferred forms of putting the disclosed coupling into effect. The disclosed coupling is, therefore, claimed in any of its forms or modifications within the legitimate and valid scope of the appended claims, appropriately interpreted in accordance with the doctrine of equivalents.

I claim:

1. A pipe coupling comprising two arcuate shaped coupling halves, at least one coupling half further comprising at least one arcuate key projecting generally radially inward, the at least one key angled relative a transverse plane of the coupling.

2. The coupling apparatus of claim 1 further comprising at least two angled keys, such that each coupling half comprises at least one of the at least two keys.

3. The coupling apparatus of claim 1 wherein the joined arcuate coupling halves form a generally ovoid opening for a pipe end, the longer axis of the ovoid opening lying in a coupling half join plane.

4. The coupling apparatus of claim 1 wherein the at least one angled key comprises a radially inwardly facing arcuate face and two side walls, a plan view of the key face being of generally parallelogramatic shape.

5. The coupling apparatus of claim 2 wherein the at least two angled keys each comprise a radially inwardly facing arcuate face and two side walls, a plan view of each face being of generally parallelogramatic shape, and the at least four side walls being of generally equivalent length to one another.

6. The coupling apparatus of claim 2 further comprising each coupling half having exactly two angled keys, one on each side of a central transverse plane.

7. The coupling apparatus of claim 6 further comprising:
the at least two angled keys each comprise a radially inwardly facing arcuate face and two side walls, a plan view of each face being of generally parallelogramatic shape, and the at least four side walls being of general ly equivalent length to one another;
the two angled keys extending radially inward the full length of the arcuate opening of the coupling half;
the two angled keys upon a single coupling half being parallel to each other.

8. A pipe coupling apparatus for joining together a pair of pipe ends in coaxial engagement, each pipe end shaped with a circumferential groove, the circumferential groove having an outside wall and an inside wall relative a central transverse plane of the coupling, the pipe coupling apparatus comprising:
a coupling formed by two arcuate shaped coupling halves;
at least one coupling half further comprising at least one key projecting substantially radially inward from the coupling half, the at least one key angled relative a transverse plane of the coupling, such that when the coupling is fastened about the pipe ends, a first at least one point of contact of the at least one key is moveable to engage the outside wall of the circumferential groove and a second at least one point of contact of the at least one key is moveable to engage the inside wall of the circumferential groove.

9. The coupling apparatus of claim 8 further comprising at least two angled keys, the at least two angled keys disposed such that:
each coupling half comprises at least one of the at least two angled keys;
each pipe's circumferential groove has at least one key of the at least two angled keys moveable to engage with the circumferential groove when the two coupling halves are circumferentially positioned about the pipe ends; and
the at least two angled keys are oppositely oriented relative the central transverse plane of the coupling when the two coupling halves are circumferentially positioned about the pipe ends.

10. The coupling apparatus of claim 8 wherein, the joined arcuate coupling halves form a generally ovoid opening for the pipes, the long axis of the oval lying in a coupling half join plane.

11. The coupling apparatus of claim 8 wherein the at least one angled key comprises a radially inwardly facing arcuate face and two side walls, a plan view of the key face being of generally parallelogramatic shape.

12. The coupling apparatus of claim 9 wherein the at least two angled keys each comprise a radially inwardly facing arcuate face and two side walls, a plan view of each face being of generally parallelogramatic shape, and the at least four side walls being of generally equivalent length to one another.

13. The coupling apparatus of claim 9 further comprising each coupling half having exactly two angled keys, one on each side of the central transverse plane.

14. The coupling apparatus of claim 13 further comprising:
the at least two angled keys each comprise a radially inwardly facing arcuate face and two side walls, a plan view of each face being of generally parallelogramatic shape, and the at least four side walls being of generally equivalent length to one another;
the two angled keys extending radially inward the full length of the arcuate opening of the coupling half;
the two angled keys upon a single coupling half being parallel to each other.

15. A pipe coupling apparatus for joining together a pair of pipe ends in coaxial engagement, each pipe end shaped with a circumferential groove, the circumferential groove having two walls, an outside wall and an inside wall relative a central transverse plane of the coupling, the pipe coupling apparatus comprising:
a coupling formed by two arcuate shaped coupling halves;
a plurality of keys projecting substantially radially inward from the coupling half;
each of the plurality of keys is angled relative the central transverse plane of the coupling, such that when the coupling is fastened about the pipe ends, each key has at least one point of contact moveable to engage at least one of the two walls of the circumferential groove;
the plurality of keys disposed such that each coupling half comprises at least one key of the plurality of angled keys;
each pipe's circumferential groove has at least one point of contact of at least one key moveable to engage the outside wall of the circumferential groove and a second at least one point of contact of at least one key moveable to engage the inside wall of the circumferential groove; and
at least two of the plurality of angled keys are oppositely oriented relative the central transverse plane of the coupling when the two coupling halves are circumferentially positioned about the pipe ends.

16. The coupling apparatus of claim 15 wherein:
each of the plurality of keys comprise a radially inwardly facing arcuate face and two side walls;
a plan view of each face of the plurality of keys being of generally parallelogramatic shape;
each side walls of each of the plurality of keys being of generally equivalent length to all other side walls; and
the two angled keys upon a single coupling half being parallel to each other.

17. A pipe coupling apparatus for joining together a pair of pipe ends in coaxial engagement, each pipe end shaped with a circumferential groove, the circumferential groove having an outside wall and an inside wall relative a central transverse plane of the coupling, the pipe coupling apparatus comprising:
a coupling formed by two arcuate shaped coupling halves;
each coupling half having two keys, one on each side of the central transverse plane, projecting substantially radially inward from the coupling half the full length of the arcuate opening of the coupling half;
each of the four keys angled relative the central transverse plane of the coupling, such that, when the coupling is fastened about the pipe ends, each key has a first at least one point of contact moveable to engage the outside wall of a circumferential groove of a pipe and a second at least one point of contact moveable to engage the inside wall of the same circumferential groove;
each of the four angled keys further comprising a radially inwardly facing arcuate face and two side walls, a plan view of each face being of generally parallelogramatic shape, and the eight side walls being of generally equivalent length to one another;
the two angled keys upon a single coupling half being parallel to each other; and
the two angled keys on one coupling half are oppositely oriented to the two angled keys on the other coupling half, when the two coupling halves are circumferentially positioned about the pipe ends.
